(19) United States
(12) Patent Application Publication
(10) Pub. No.: US 2021/0226501 A1
(43) Pub. Date: Jul. 22, 2021

(54) MOTOR

(71) Applicant: NIDEC CORPORATION, Kyoto (JP)

(72) Inventors: Tatsuro KAWAMOTO, Kyoto (JP); Yunpeng LI, Liaoning (CN); Meidan MU, Liaoning (CN); Yunting HUANG, Liaoning (CN); Xiuquan DONG, Liaoning (CN); Cui LI, Liaoning (CN)

(73) Assignee: NIDEC CORPORATION, Kyoto (JP)

(21) Appl. No.: 17/152,813

(22) Filed: Jan. 20, 2021

(30) Foreign Application Priority Data
Jan. 22, 2020 (CN) 202010073943.2

(51) Int. Cl. H02K 3/50; H02K 5/22; H02K 3/04; H02K 3/52

(52) U.S. Cl. CPC H02K 3/50; H02K 5/225; H02K 2203/09; H02K 3/522; H02K 3/04

(57) ABSTRACT

The embodiments of the disclosure provide a motor. The motor includes a rotor, a stator, and a bus bar unit. The bus bar unit includes a bus bar and a bus bar holder. The bus bar includes: a first connecting portion; a second connecting portion; a bending portion which connects the first connecting portion and the second connecting portion; and a slit that penetrates the first connecting portion and the second connecting portion. A lead-out portion of the winding is located inside the slit, and electrically connected to the first connecting portion and the second connecting portion.

### CROSS-REFERENCE TO RELATED APPLICATION

This application claims the priority benefit of China application serial no. 202010073943.2, filed on Jan. 22, 2020. The entirety of the above-mentioned patent application is hereby incorporated by reference herein and made a part of this specification.

### BACKGROUND

### Field of the Disclosure

The disclosure relate to the electromechanical field, and particularly to a motor.

### Description of Related Art

Motors are widely applied to various electromechanical equipment, including various household appliances, office automation equipment, industrial equipment, transportation equipment, etc. Typically, a motor includes a bus bar unit. The bus bar unit has a bus bar holder and a bus bar. The bus bar is arranged inside the bus bar holder and its end portion is exposed from the bus bar holder. The end portion of the bus bar is electrically connected to the winding inside the motor.

It should be noted that the above introduction to the technical background is only set forth to provide a clear and thorough description of the technical solution of the disclosure and facilitate understanding of those skilled in the art. It should not be construed that the above technical solutions are commonly known to those skilled in the art just because these solutions are described in the background art of this disclosure.

### SUMMARY OF THE DISCLOSURE

However, the inventors of the disclosure found that there are some limitations in the existing structure in which the end portion of bus bar is electrically connected to the winding. For example, in some structures, welding is used for connection, and the connection operation is complicated. In another example, in other structures, a snap-fit structure is used for connection, but such a structure cannot fully guarantee the area where the bus bar is electrically connected to the winding, which causes the problem of increased contact resistance and results in heat that is generated at the area where the bus bar is electrically connected to the winding.

In order to solve at least one of the above-mentioned problems or other similar problems, the embodiments of the disclosure provide a motor. The connection operation for connecting the bus bar and the winding is simple, and the area for electrically connecting the bus bar and the winding is large enough to suppress the increase in contact resistance, thereby preventing heat from being generated at the area where the bus bar and the winding is electrically connected.

According to an aspect of the embodiments of the disclosure, a motor is provided, the motor includes a rotor, which has a shaft centered on a central axis extending in an axial direction; a stator, which is arranged radially opposite to the rotor and having a plurality of coils; and a bus bar unit, which is arranged at one side of the stator in the axial direction.

The bus bar unit includes: a bus bar that is electrically connected to the lead-out portion of the winding that forms the coil; and a bus bar holder, which is made of resin and covers at least part of the bus bar.

The bus bar includes: a first connecting portion; a second connecting portion; a bending portion connecting the first connecting portion and the second connecting portion; and a slit passing through the first connecting portion and the second connecting portion.

The lead-out portion of the winding is located in the slit and is electrically connected to the first connecting portion and the second connecting portion.

In one or more embodiments, the number of the slits is one or more.

In one or more embodiments, the first connecting portion and the second connecting portion extend to the other side in the axial direction from the bending portion, and the slit passes through the first connecting portion and the second connecting portion in the radial direction.

In one or more embodiments, the first connecting portion and the second connecting portion extend from the bending portion along the radial direction, and the slit passes through the first connecting portion and the second connecting portion in the axial direction.

In one or more embodiments, the width of at least a part of the slit is narrower than the diameter of the winding.

In one or more embodiments, the slit is not provided in a portion of the second connecting portion away from the bending portion.

In one or more embodiments, the bus bar holder includes a connection support portion that protrudes from a surface of the bus bar holder on one side in the axial direction, and clamps the first connecting portion and the second connecting portion in the circumferential direction.

In one or more embodiments, the bus bar holder has: a cylindrical body portion; a connector portion protruding outward in the radial direction from the body portion; and a bottom portion extending inward in the radial direction from the inner surface of the body portion.

The bottom portion has a through hole penetrating in the axial direction, the lead-out portion of the winding passes through the through hole and is wound on the one side of the bottom portion in the axial direction. The lead-out portion of the winding is electrically connected to a part of the bus bar configured at the inner side of the connector portion in the radial direction.

In one or more embodiments, the motor further includes a circuit board, which is disposed at one side of the bus bar holder in the axial direction and is electrically connected to the stator of the motor, and is provided with a connecting hole.

The bus bar unit further includes a sensor connector, which is located on one side of the bus bar in the axial direction, and at least a part of the sensor connector is covered by the bus bar holder. The sensor connector has a press-fit structure that is closer to the outer side in the radial direction than the end portion of the bus bar at the inner side in the radial direction, and the press-fit structure is press-fitted into the connecting hole of the circuit board and electrically connected to the circuit board.

The bottom portion has a circuit board support portion that extends to one side in the axial direction from the bottom portion and is in contact with a surface of the circuit board on the other side in the axial direction. The circuit board fixing portion extends to one side in the axial direction from the bottom portion, and fixes the circuit board along with the outer edge of the circuit board in the radial direction through a snap-fit structure.

In one or more embodiments, the bottom portion further has a winding support portion that protrudes from a surface of the bottom portion on one side in the axial direction. The winding support portion has a recess, and the lead-out portion of the winding is embedded into the recess.

In one or more embodiments, the number of the bus bars is at least 3, and each of the bus bars has the same shape.

In one or more embodiments, the bottom portion further has a winding support portion, which protrudes from a surface of the bottom portion on one side in the axial direction, the number of the bus bars is three, and the winding support portion is located between the bus bar in the middle position among the three bus bars and the through hole.

In one or more embodiments, the through hole has a recessed portion recessed toward the bus bar, and the lead-out portion of the winding is embedded in the recessed portion.

In one or more embodiments, the bottom portion is provided with a winding guiding portion, the winding guiding portion protrudes to one side in the axial direction from the surface of the bottom portion at one side in the axial direction, and a portion, ranging from the through hole to a position between the first connecting portion and the second connecting portion, of the lead-out portion of the winding is located between the winding guiding portion and the body portion in the radial direction.

In one or more embodiments, the motor further includes a cover member made of resin, which covers the bus bar holder from one side in the axial direction.

The cover member has a flange plate portion that extends in the radial direction, and axially contacts an end surface of the body portion at one side in the axial direction; a peripheral wall portion that extends to one side in the axial direction from the end portion of the flange plate portion at the inner side in the radial direction; and a top plate portion that extends inward in the radial direction from the end portion of the peripheral wall portion at one side in the axial direction.

The top plate portion has a winding pressing portion that protrudes to the other side in the axial direction from a surface of the top plate portion on the other side in the axial direction, and is in contact with the lead-out portion of the winding.

In one or more embodiments, the top plate portion includes: a plane portion, which is perpendicular to the axial direction; and an inclined portion, which is connected to the plane portion, and the portion where the inclined portion is connected to the plane portion extends to the portion away from the plane portion toward the other side in the axial direction.

In one or more embodiments, the inclined portion is located at a position closer to the outer side in the radial direction than the central axis.

The plane portion and the central axis coincide in the axial direction.

In one or more embodiments, the motor further has a housing that holds the bus bar unit and the stator, the rotor is located inside the housing, and the housing has a cylindrical portion extending in the axial direction.

The cylindrical portion has: a first cylindrical portion; a second cylindrical portion, the second cylindrical portion is located at one side of the first cylindrical portion in the axial direction, and the second cylindrical portion has a diameter larger than the first cylindrical portion; and a stepped portion that extends outward in the radial direction from an end portion of the first cylindrical portion at one side in the axial direction, and is connected to an end portion of the second cylindrical portion at the other side in the axial direction.

The motor further has a ring member located at one side of the stepped portion in the axial direction, and is configured between the inner surface of the second cylindrical portion in the radial direction and the outer surface of the housing insertion portion of the bus bar holder in the radial direction. The housing insertion portion is formed by extending from an end surface on the other side of the bus bar holder in the axial direction toward the other side in the axial direction.

In one or more embodiments, the motor further has a metal housing, the housing holds the bus bar unit and the stator, and the rotor is located inside the housing.

The housing has: a cylindrical portion extending in the axial direction; and a housing flange plate portion that extends outward in the radial direction from an end portion of the cylindrical portion at one side in the axial direction.

The housing flange plate portion has: a flange portion that protrudes to one side in the axial direction from the housing flange plate portion, and is inserted into a first mounting hole of the flange portion of the bus bar holder. The first mounting hole axially penetrates a portion of the body portion of the bus bar holder extending outward in the radial direction, and the flange portion has a second mounting hole penetrating in the axial direction inside the flange portion.

In one or more embodiments, the flange portion has an annular portion located at the end portion at one side in the axial direction and extending inward in the radial direction.

One of the beneficial effects of the embodiment of the disclosure is that the bus bar includes a first connecting portion and a second connecting portion connected through a bending portion, and the lead-out portion of the winding is located in a slit passing through the first connecting portion and the second connecting portion to be electrically connected to the first connecting portion and the second connecting portion. That is, the lead-out portion of the winding is sequentially connected to the two connecting portions, thus ensuring the area where the bus bar is electrically connected to the winding, suppressing the increase of the contact resistance, and preventing the heat from being generated at where the bus bar is electrically connected to the winding. In addition, the connection operation for connecting the bus bar and the winding is simple.

With reference to the following description and drawings, the embodiments of the present disclosure are disclosed in detail. It should be understood that the scope of the embodiments of the present disclosure is not limited thereby. Within the spirit and scope of the terms of the appended claims, the embodiments of the present disclosure include many changes, modifications and equivalents thereof.

Features described and/or illustrated in one embodiment can be used in one or more other embodiments in the same or similar manner, combined with features in other embodiments, or substituted for features in other embodiments.

It should be emphasized that the term “comprising/including/having” used herein refers to the presence of a feature, whole piece, or element, but does not exclude the presence or addition of one or more other features, whole pieces or elements.

### BRIEF DESCRIPTION OF THE DRAWINGS

In the following detailed description with reference to the accompanying drawings, the above and other objectives, features and advantages of the embodiments of the present disclosure will become more apparent. In the accompanying drawings:

FIG. 1 is a cross-sectional view of a motor according to an embodiment of the disclosure.

FIG. 2 is a schematic view of a bus bar according to an embodiment of the disclosure.

FIG. 3 is another schematic view of a bus bar according to an embodiment of the disclosure.

FIG. 4 is still another schematic view of the bus bar shown in FIG. 3.

FIG. 5 is a schematic view of the bus bar in the motor according to an embodiment of the disclosure.

FIG. 6 is another schematic view of the bus bar in the motor according to an embodiment of the disclosure.

FIG. 7 is a schematic view of a bus bar unit according to an embodiment of the disclosure.

FIG. 8 is another schematic view of the bus bar unit according to an embodiment of the disclosure.

FIG. 9 is a schematic view of a circuit board according to an embodiment of the disclosure.

FIG. 10 is a schematic view showing the circuit board shown in FIG. 9 arranged in the bus bar unit shown in FIG. 7 according to an embodiment of the disclosure.

FIG. 11 is a cross-sectional view of the structure shown in FIG. 10 taken along the line D-D in FIG. 10 along the axial direction according to an embodiment of the disclosure.

FIG. 12 is an enlarged schematic view of part A in FIG. 7.

FIG. 13 is a schematic view showing the lead-out portion of the winding in the structure shown in FIG. 12.

FIG. 14 is an enlarged schematic view of part B in FIG. 8.

FIG. 15 is a partial schematic view showing the motor including three bus bar holders as shown in FIG. 5 according to an embodiment of the disclosure.

FIG. 16 is a schematic view of a cover member according to an embodiment of the disclosure.

FIG. 17 is another schematic view of the cover member shown in FIG. 16 according to an embodiment of the disclosure.

FIG. 18 is a cross-sectional view of another structure of the motor according to an embodiment of the disclosure.

FIG. 19 is a schematic view of a housing according to an embodiment of the disclosure.

FIG. 20 is a schematic view of another structure of the housing according to an embodiment of the disclosure.

### DESCRIPTION OF EMBODIMENTS

With reference to the accompanying drawings, the foregoing and other features of this disclosure will become apparent with reference to the following description. In the description and drawings, specific implementations of the disclosure are explicitly disclosed, which indicate some implementations in which the principles of the disclosure can be adopted. It should be understood that the disclosure is not limited to the described implementations, on the contrary, the disclosure includes all modifications, variations and equivalent replacement which fall within the scope of the appended claims.

In the embodiments of the disclosure, the term “and/or” includes any one and all combinations of one or more of the associated terms. The terms “comprising”, “including”, “having” and the like refer to the existence of the described features, elements, components or members, but do not exclude the presence or addition of one or more other features, elements, components or members.

In the embodiments of the disclosure, the singular forms “a”, “the”, etc. may include plural forms, which should be broadly understood as “a kind of” or “a type of” rather than being limited to the meaning of “one”. In addition, the term “the” should be construed to involve both singular and plural forms, unless otherwise indicated. Moreover, the term “according to” should be construed as “at least partially according to . . . ”, and the term “based on” should be construed as “at least partially based on . . . ” unless otherwise indicated.

In addition, in the following description of the disclosure, for the convenience of description, the direction parallel to the direction extending along the central axis OO′ (e.g., center circumference OO′) of the motor is referred to as the “axial direction”. The radial direction centered on the central axis OO′ is referred to as the “radial direction”. The direction around the central axis OO′ is referred to as the “circumferential direction”. However, it should be noted that the above descriptions of directions are only for convenience of description and do not limit the direction along which the motor faces during use and manufacturing.

Hereinafter, the motor of the embodiment of the disclosure will be described with reference to the drawings.

### Embodiment

An embodiment of the disclosure provides a motor.

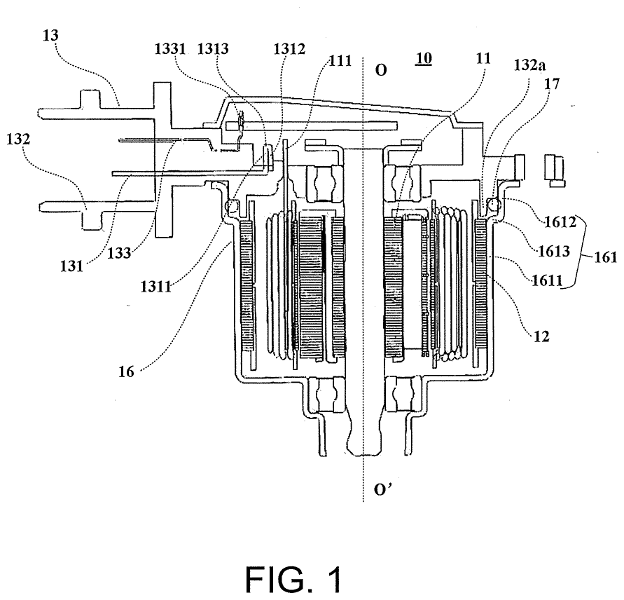

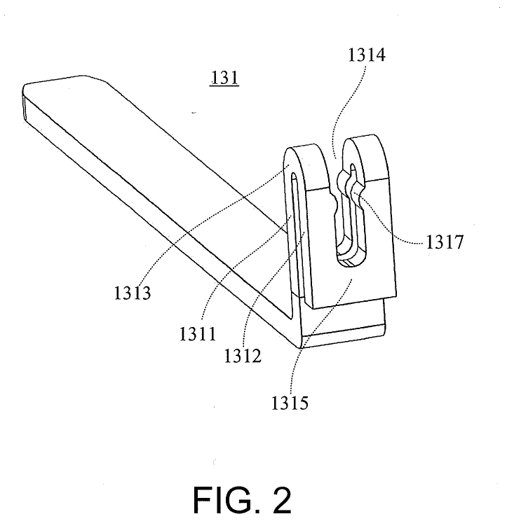

FIG. 1 is a cross-sectional view of the motor according to an embodiment of the disclosure, showing that the motor is taken along a plane passing through the central axis 00′, and FIG. 2 is a schematic view of the bus bar according to an embodiment of the disclosure.

As shown in FIG. 1, the motor 10 includes a rotor 11, a stator 12 and a bus bar unit 13. The rotor 11 has a shaft centered on a center axis OO′ extending in the axial direction, the stator 12 and the rotor 11 are arranged radially opposite to each other and have a plurality of coils, and the bus bar unit 13 is arranged on one side (side O) of the stator 12 in the axial direction.

As shown in FIG. 1 and FIG. 2, the bus bar unit 13 includes a bus bar 131 and a bus bar holder 132 (not shown in FIG. 2). The bus bar 131 is electrically connected to the lead-out portion 111 of the winding forming the coil. It is worth noting that, in order to easily show the bus bar 131, the bus bar 131 and the lead-out portion 111 of the winding in FIG. 1 are not yet connected. The bus bar holder 132 is made of resin and covers at least a part of the bus bar 131.

In one or more embodiments, as shown in FIG. 1 and FIG. 2, the bus bar 131 includes: a first connecting portion 1311, a second connecting portion 1312, a bending portion 1313, and a slit 1314 (not shown in FIG. 1). The bending portion 1313 connects the first connecting portion 1311 and the second connecting portion 1312, the slit 1314 penetrates the first connecting portion 1311 and the second connecting portion 1312, and the lead-out portion 111 of the winding is located in the slit 1314 and is electrically connected to the first connecting portion 1311 and the second connecting portion 1312. That is, the lead-out portion 111 of the winding is electrically connected to the first connecting portion 1311 and the second connecting portion 1312 along the length direction of the bus bar 131 within the slit 1314. In other words, the first connecting portion 1311 and the second connecting portion 1312 are respectively formed with slits, and the lead-out portion 111 of the winding is located in the slits formed by the first connecting portion 1311 and the second connecting portion 1312 to be electrically connected to the first connecting portion 1311 and the second connecting portion 1312, respectively.

It can be seen from the above embodiment that the bus bar includes a first connecting portion and a second connecting portion connected through a bending portion, and the lead-out portion of the winding is located at a slit passing through the first connecting portion and the second connecting portion to be electrically connected to the first connecting portion and the second connecting portion. That is, the lead-out portion of the winding is sequentially connected to the two connecting portions, thus ensuring the area where the bus bar is electrically connected to the winding, suppressing the increase of the contact resistance, and preventing the heat from being generated at where the bus bar is electrically connected to the winding. In addition, the connection operation for connecting the bus bar and the winding is simple.

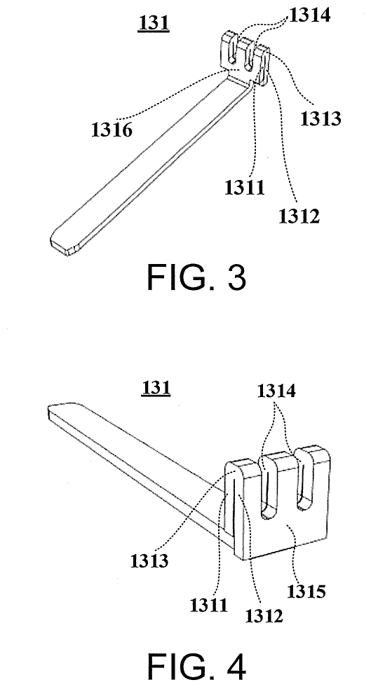

FIG. 2 shows the structure of a bus bar according to an embodiment of the disclosure, but the disclosure is not limited thereto. FIG. 3 is another schematic view of the bus bar according to an embodiment of the disclosure. FIG. 4 is still another schematic view of the bus bar shown in FIG. 3 viewed from another direction.

In one or more embodiments, the number of slits 1314 in one bus bar 131 may be one as shown in FIG. 2, that is, one slit 1314 is set along the width direction of the bus bar 131. However, the application is not limited thereto. For example, the number of slits 1314 in one bus bar 131 may be two as shown in FIG. 3 and FIG. 4, that is, two slits 1314 are set along the width direction of the bus bar 131. In addition, the number of slits 1314 in one bus bar 131 can also be other values, that is, multiple slits 1314 are set along the width direction of the bus bar 131, such as 3 or 4, which should not be construed as a limitation to the disclosure. Those skilled in the art can make configuration according to actual needs, for example, according to the type of the motor, the configuration method of the winding in the motor, and so on. In this manner, the needs of different designs can be satisfied. It should be noted that the number of slits in a bus bar is 1 or n, which means that there are 1 or n slits formed in the first connecting portion and the second connecting portion of the bus bar.

In one or more embodiments, as shown in FIG. 1, FIG. 2, FIG. 3, and FIG. 4, the first connecting portion 1311 and the second connecting portion 1312 extend to the other side (side O′) in the axial direction from the bending portion 1313, and the slit 1314 penetrates the first connecting portion 1311 and the second connecting portion 1312 in the radial direction. However, the disclosure is not limited thereto. The first connecting portion and the second connecting portion may also extend in other directions. For example, the first connecting portion 1311 and the second connecting portion 1312 may extend along the radial direction from the bending portion 1313, that is, at least part of the first connecting portion 1311 and the second connecting portion 1312 overlap in the axial direction, and the slit penetrates the first connecting portion and the second connecting portion in the axial direction. Additionally, the first connecting portion and the second connecting portion may also extend along other directions at a certain angle with respect to the axial direction or radial direction, and those skilled in the art can make configuration according to actual needs. The following part of the description takes the first connecting portion 1311 and the second connecting portion 1312 as an example of the structure extending in the axial direction. For the structure of the first connecting portion 1311 and the second connecting portion 1312 extending in other directions, please refer to the following related content.

In one or more embodiments, as shown in FIG. 1, FIG. 2, FIG. 3, and FIG. 4, the first connecting portion 1311 and the second connecting portion 1312 may be in plate shape substantially parallel to each other, and there may be a certain gap between the first connecting portion 1311 and the second connecting portion 1312. However, the disclosure is not limited thereto. For example, the first connecting portion 1311 and the second connecting portion 1312 may not be parallel to each other and have a certain included angle formed therebetween. In this manner, when the lead-out portion of the winding is located at the slit penetrating the first connecting portion and the second connecting portion to be electrically connected to the first connecting portion and the second connecting portion, it is possible to further increase the area where the bus bar and the winding are electrically connected to each other, thus suppressing the increase in contact resistance and preventing the heat from being generated at where the bus bar and the winding are electrically connected to each other. As for the size of the included angle between the first connecting portion 1311 and the second connecting portion 1312, those skilled in the art can set the included angle as needed, and the disclosure provides no limitation thereto.

In one or more embodiments, as shown in FIG. 1, FIG. 2, FIG. 3, and FIG. 4, the bus bar 131 includes a single bend, that is, the cross section of the bus bar as shown in FIG. 1 is U-shaped or n-shaped, but the disclosure is not limited thereto. For example, the bus bar may also include multiple bends, for example, 2 bends, that is, the cross-section of the bus bar in the direction shown in FIG. 1 may be N-shaped, or, 3 or more than 3 bends, that is, the cross-section of the bus bar can be W-shaped or m-shaped and the like. In this manner, it is possible to further increase the area where the bus bar is electrically connected to the winding, thereby suppressing the increase of the contact resistance, and preventing the heat from being generated at where the bus bar is electrically connected to the winding.

In one or more embodiments, the width of at least a portion of the slit 1314 is narrower than the diameter of the winding. In this manner, it is possible to prevent the winding from falling off the slit. As shown in FIG. 2, the end O of the slit 1314 is provided with a protrusion 1317, which should not be construed as a limitation, and other methods can also be adopted as long as the width of at least a part of the slit 1314 is narrower than the diameter of the winding. It should be noted that in this disclosure, the winding is electrically connected to the bus bar. Therefore, unless otherwise specified, the diameter of the winding refers to the diameter of the winding that excludes the exposed wire covering the insulating part (such as the sheath) on the outer circumference.

In one or more embodiments, as shown in FIG. 2 and FIG. 4, the portion of the second connecting portion 1312 away from the bending portion 1313 is not provided with a slit, that is, the portion at the side O′ of the second connecting portion 1312 in the axial direction is connected without slits, and may be referred to as a connecting portion 1315.

In this manner, when the winding is pressed into or located in the slit, it is possible to suppress the first connecting portion and the second connecting portion of the bus bar from being deformed outward in the radial direction, that is, inhibiting the bus bar from being deformed in the circumferential direction. In addition, as shown in FIG. 3, the first connecting portion 1312 may also be provided with a connecting portion 1316 configured in a manner similar to the connecting portion 1315.

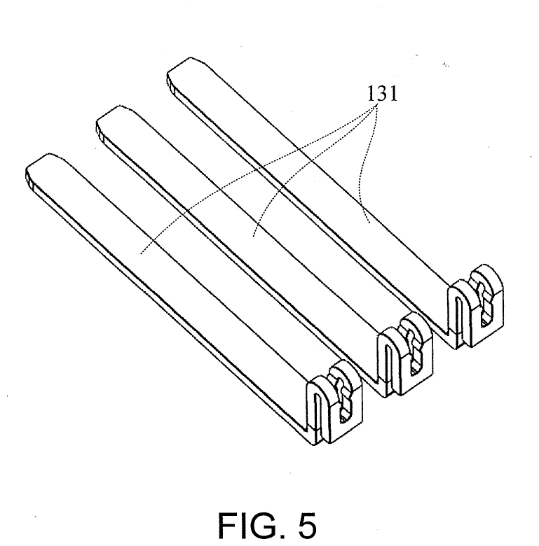

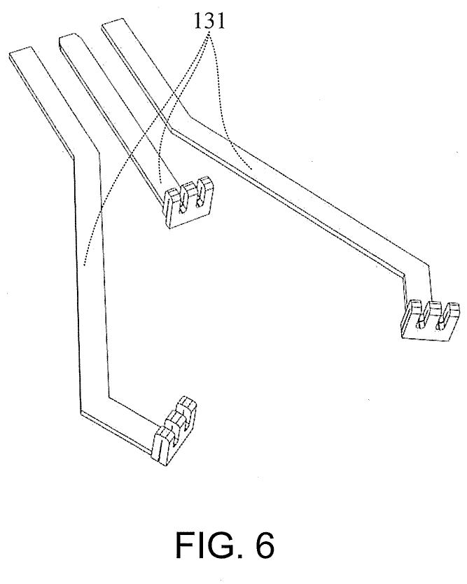

FIG. 5 is a schematic view of the bus bar in the motor according to an embodiment of the disclosure. FIG. 6 is another schematic view of the bus bar in the motor according to an embodiment of the disclosure. As shown in FIG. 5 and FIG. 6, the number of bus bars 131 provided in the motor 10 may be three, and in one motor, the shape of each bus bar 131 may be the same or different. However, the disclosure is not limited thereto. The number of bus bars 131 provided in the motor 10 can be other values, such as 1, 2, or 3 or more, which can be set by those skilled in the art according to actual needs. Moreover, the shape of each of the bus bars can also be designed by those skilled in the art according to actual needs, and the disclosure provides no limitation thereto.

The bus bar has been explicitly described above, and the bus bar holder for setting the bus bar will be explicitly described below.

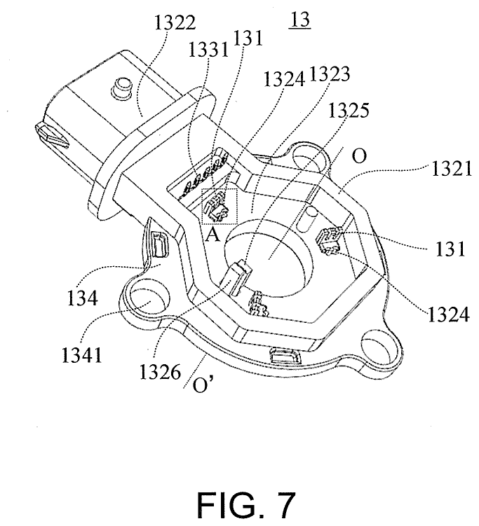

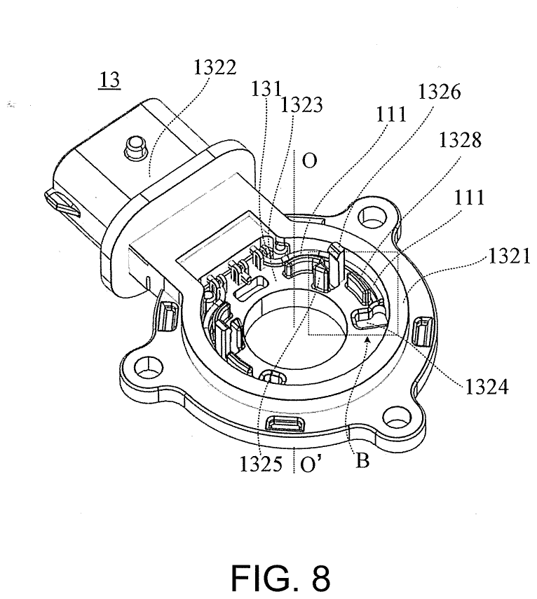

FIG. 7 is a schematic view of a bus bar unit according to an embodiment of the disclosure. FIG. 8 is another schematic view of the bus bar unit according to an embodiment of the disclosure.

As shown in FIG. 7 and FIG. 8, the bus bar holder 132 has a cylindrical body portion 1321, a connector portion 1322 and a bottom portion 1323. The connector portion 1322 protrudes outward in the radial direction from the body portion 1321, the bottom portion 1323 extends inward in the radial direction from the inner surface of the body portion 1321, and the bottom portion 1323 has a through hole 1324 penetrating in the axial direction. In the embodiment of the disclosure, the body portion 1321 is cylindrical, including a standard cylindrical shape and a substantially cylindrical shape. For example, the body portion 1321 may have a substantially cylindrical cross-section that is formed by a polygonal shape or a substantially polygonal shape, or have a roughly circular cross-section formed by a substantially cylindrical shape.

In one or more embodiments, as shown in FIG. 8, the lead-out portion 111 of the winding passes through the through hole 1324 and is wound at one side (side O) of the bottom portion 1323 in the axial direction. The lead-out portion 111 of the winding is electrically connected to a portion of the bus bar 131 arranged at the inner side of the connector portion 1322 in the radial direction. In other words, on the surface of the bottom portion 1323 of the bus bar holder 132 at one side in the axial direction, there is a certain distance between the configuration position (referred to as position 1) of the through hole 1324 and the position (referred to as position 2) of the end portion (i.e., the end portion for electrically connected to the winding) of the bus bar 131 located at the inner side of the connector portion 1322 in the radial direction. When the winding is wound on the stator, the operator or operating machine holds one end of the winding. After the winding is wound on the stator, the held piece of winding can serve as the lead-out portion of the winding and is configured between the position 1 and the position 2, so it is possible to reduce the waste of winding. In addition, in the structure of the disclosure where the winding and the bus bar are electrically connected to each other, since the winding does not need to be wound around the bus bar, the shape of the bus bar can be simplified.

In one or more embodiments, as shown in FIG. 8, the bottom portion 1323 is provided with a winding guiding portion 1328, and the winding guiding portion 1328 protrudes to one side (side O) in the axial direction from a surface of the bottom portion 1323 at one side (side O) in the axial direction. A portion of the lead-out portion 111 of the winding located between the through hole 1324 and the position between the first connecting portion and the second connecting portion is located between the winding guiding portion 1328 and the body portion 1321 in the radial direction. In this manner, the winding can be would in a good manner through the configuration of the winding guide and the body portion located at one side of the bus bar holder in the axial direction, such that the lead-out portion of the winding does not interfere with other components at the bottom portion.

However, the disclosure is not limited thereto. For example, as shown in FIG. 7, on the surface of the bottom portion 1323 of the bus bar holder 132 at one side in the axial direction, the configuration position of the through hole 1324 and the position of the end portion (including the end portion located at the inner side of the connector portion 1322 in the radial direction) of the bus bar 131 for being electrically connected to the winding may be adjacent to each other, and the disclosure provides no limitation thereto. Those skilled in the art can make selections according to actual needs.

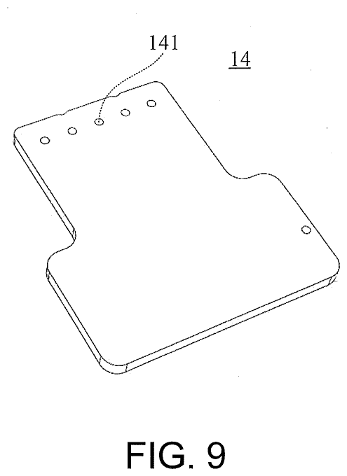

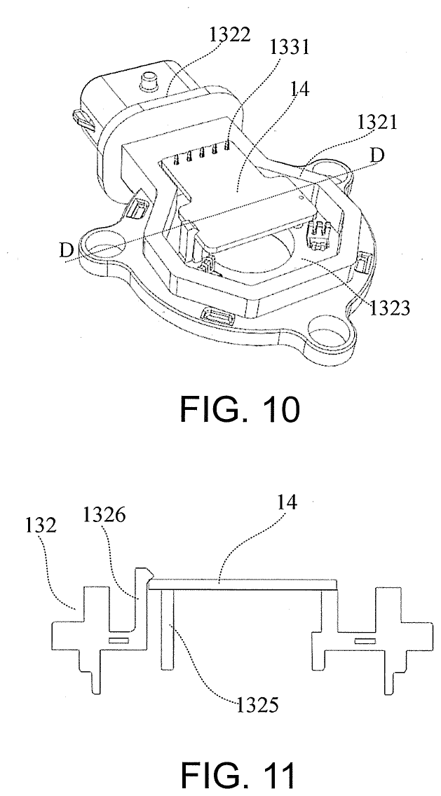

FIG. 9 is a schematic view of a circuit board according to an embodiment of the disclosure. FIG. 10 is a schematic view showing the circuit board shown in FIG. 9 arranged in the bus bar unit shown in FIG. 7 according to an embodiment of the disclosure. FIG. 11 is a cross-sectional view of the structure shown in FIG. 10 taken along the line D-D in FIG. 10 along the axial direction according to an embodiment of the disclosure.

As shown in FIG. 7 to FIG. 11 and FIG. 1, the motor 10 further includes a circuit board 14. The circuit board 14 is arranged at one side (side O) of the bus bar holder 132 in the axial direction and is electrically connected to the stator of the motor. The circuit board 14 is provided with a connecting hole 141, and the bus bar unit 13 further includes a sensor connector 133. The sensor connector 133 is located at one side (side O) of the bus bar 131 in the axial direction and at least a part of the sensor connector 133 is covered by the bus bar holder 132. The sensor connector 133 has a press-fit structure 1331, which is closer to the outer side in the radial direction than the end portion of the bus bar 131 at the inner side in the radial direction, and the press-fit structure 1331 is press-fitted into the connecting hole 141 of the circuit board 14 and is electrically connected to the circuit board 14. In this manner, it is possible to realize the electrical connection between the circuit board and the sensor connector by simply pressing in the axial direction, and the operation is simple. For the details regarding the press-fit structure, reference can be made to related technologies, and the description is omitted here. In addition, it is not limited in the disclosure that the electrical connection between the circuit board and the sensor connector is realized through the press-fit structure and the connecting hole, other methods may also be adopted, and persons skilled in the art can make selections according to actual needs.

In one or more embodiments, as shown in FIG. 7 to FIG. 11, the bottom portion 1323 has a circuit board support portion 1325 and a circuit board fixing portion 1326, and the circuit board support portion 1325 extends to one side (side O) in the axial direction from the bottom portion 1323, and is in contact with the surface of the circuit board 14 at the other side (side O′) in the axial direction. The circuit board fixing portion 1326 extends to one side in the axial direction from the bottom portion 1323, and fixes the circuit board 14 along with the outer edge of the circuit board 14 in the radial direction through the snap-fit structure. In this manner, the circuit board can be fixed by simply pressing the circuit board into the snap-fit structure in the axial direction, and the operation is simple. Moreover, it is not limited in the disclosure that the circuit board is fixed at the bus bar holder through the snap-fit structure, other methods may also be adopted, and persons skilled in the art can make selections according to actual needs.

In the embodiment of the disclosure, the lead-out portion of the winding is pressed into the slit formed by the bus bar to realize the electrical connection between the winding and the bus bar. The winding does not protrude toward the side O in the axial direction with respect to the bus bar. In this manner, it will suffice as long as the height of the circuit board support portion 1325 protruding from the surface at the side O of the bottom portion 1323 is equal to or slightly larger than the height of the bus bar 131 protruding from the surface at the side O of the bottom portion 1323. Such configuration can shorten the distance between the circuit board and the bottom portion, thereby preventing the axial size of the motor from being too large.

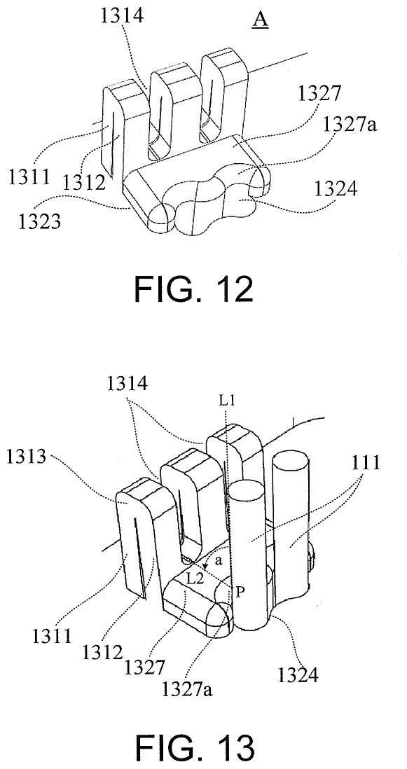

FIG. 12 is an enlarged schematic view of part A in FIG. 7. FIG. 13 is a schematic view showing the lead-out portion of the winding in the structure shown in FIG. 12, and illustrating the situation where the lead-out portion of the winding and the slit 1314 of the bus bar are not connected yet. As shown in FIG. 7, FIG. 12 and FIG. 13, in one or more embodiments, the bottom portion 1323 further has a winding support portion 1327. The winding support portion 1327 protrudes from the surface of the bottom portion 1323 at one side (side O) in the axial direction, the winding support portion 1327 has a recess 1327a , and the lead-out portion 111 of the winding (the winding is not shown in the figure) is embedded into the recess 1327a . In this manner, with the recess, the lead-out portion of the winding at the stator side can be easily brought out toward the side O of the bus bar holder in the axial direction. For example, as shown in FIG. 13, by providing a winding support portion 1327 having a recess 1327a , the lead-out portion 111 of the winding passing through the through hole 1324 can be bent by using a position where the winding and the winding support portion 1327 are in contact as a pivot (the intersection point P of the straight line L1 and the straight line L2 in FIG. 13), and the lead-out portion 111 of the winding is pressed into the slit 1314 along the direction a, such that the lead-out portion 111 of the winding is connected with the slits of the second connecting portion and the first connecting portion. Specifically, the part of the winding pressed into the slit 1314 is stripped exposed wire for electrically connecting the winding and the bus bar.

In one or more embodiments, as described above, the number of bus bars provided in the motor can be one or more, and each bus bar can be provided with a winding support portion, but the disclosure is not limited thereto. For example, when the number of bus bars is multiple, any one or more of the bus bars can be provided with a winding support portion. For example, when the motor is provided with three bus bars as shown in FIG. 5 or FIG. 6, any one of the bus bars (for example, the bus bar in the middle position) can be provided with a winding support portion, or all of the three bus bars can be provided with a winding support portion, or other arrangements are possible. This disclosure provides no limitation thereto, and those skilled in the art can make arrangement according to actual needs. In this embodiment, the configuration position of the winding support portion on the surface of the bottom portion 1323 at the side O in the axial direction can be any position between the bus bar and the through hole, for example, the position near the through hole. In addition, the number of the recess in the winding support portion is the same as the number of the slit in the bus bar, but the disclosure is not limited thereto, and the number the recess in the winding support portion may be different from the number of the slit in the bus bar.

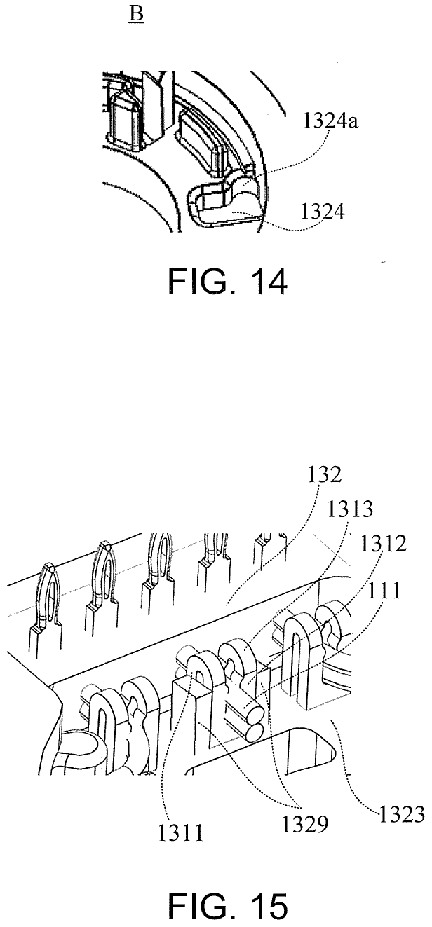

FIG. 14 is an enlarged schematic view of part B in FIG. 8. As shown in FIG. 8 and FIG. 14, the through hole 1324 has a recessed portion 1324a recessed toward the bus bar 131, and the lead-out portion 111 of the winding is embedded into the recessed portion 1324a . In this manner, the lead-out portion of the winding can be easily wound in the direction of the bus bar at the bottom portion.

FIG. 15 is a partial schematic view showing the motor including three bus bar holders as shown in FIG. 5 according to an embodiment of the disclosure, and showing the electrical connection between the lead-out portion of the winding and the bus bar holder.

As shown in FIG. 15, in one or more embodiments, the bus bar holder includes a connection support portion 1329, which protrudes from a surface of the bus bar holder 132 at one side (side O) in the axial direction, and clamps the first connecting portion 1311 and the second connecting portion 1312 in the circumferential direction. In this manner, when the winding is pressed into or located in the slit, it is possible to further prevent the bus bar from being deformed at the outer side in the radial direction, that is, to prevent the bus bar from being deformed in the circumferential direction. FIG. 15 shows that the bus bar in the middle position among the three bus bars is provided with a connection support portion 1329, but the disclosure is not limited thereto, and any one or more of the provided bus bars can be provided with a connection support portion. Those skilled in the art can make a selection according to actual needs. In addition, in the case where the bus bar is arranged in other ways, the arrangement of the connection support portion can be derived from the above descriptions, and the details are omitted herein. In this embodiment, the height of the connection support portion 1329 in the axial direction is smaller than the height of the bus bar protruding from the surface of the bus bar holder 132 at one side (side O) in the axial direction, but the disclosure is not limited thereto, and the height of the former one may be equal to or slightly higher than the latter one, so that the effect of suppressing deformation can be further enhanced.

The bus bar holder has been described in detail above, and the other parts of the motor, such as the cover member and the housing, will be described in detail below.

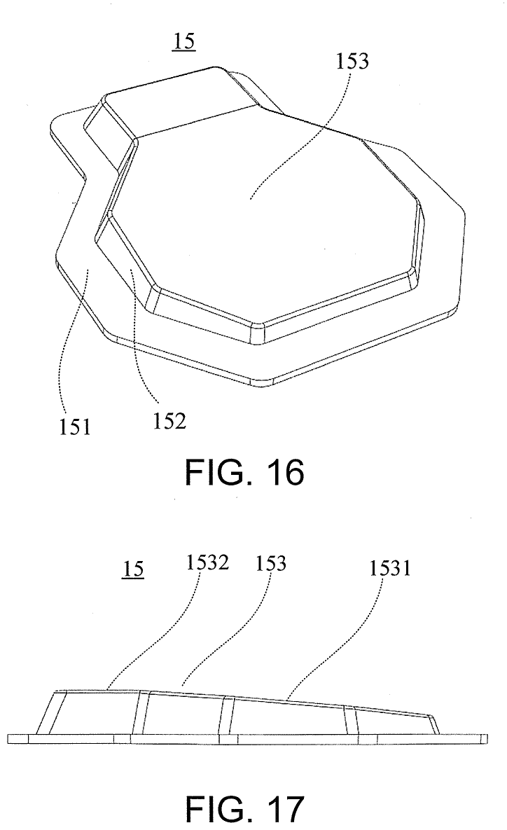

FIG. 16 is a schematic view of a cover member according to an embodiment of the disclosure. As shown in FIG. 1 and FIG. 16, the motor 10 further includes a cover member 15 which is made of resin and covers the bus bar holder 132 from one side in the axial direction.

As shown in FIG. 1 and FIG. 16, the cover member 15 has a flange plate portion 151, a peripheral wall portion 152 and a top plate portion 153. The flange plate portion 151 extends in the radial direction and is axially in contact with the end surface of the body portion 1321 at one side (side O) in the axial direction of the bus bar holder 132. The peripheral wall portion 152 extends to one side (side O) in the axial direction from the end portion of the flange plate portion 151 at the inner side in the radial direction, and the top plate portion 153 extends inward in the radial direction from the end portion of the peripheral wall portion 152 at one side (side O) in the axial direction.

In one or more embodiments, the top plate portion 153 has a winding pressing portion that protrudes to the other side (side O′) in the axial direction from the surface of the top plate portion 153 at the other side (side O′) in the axial direction, and is in contact with the lead-out portion 111 of the winding. In this manner, by arranging the winding pressing portion, it is possible to prevent the winding disposed between the body portion and the winding guiding portion from moving the axial direction. Moreover, it is possible to prevent the lead-out portion of the winding pressed in the slit from falling off in the axial direction. In the embodiment of the disclosure, the winding pressing portion may be, for example, a shape having a concave, but the disclosure is not limited thereto, and the winding pressing portion may also be any other shape. Furthermore, the disclosure provides no limitation to the number of winding pressing portions. Persons skilled in the art can make arrangement according to actual needs.

FIG. 17 is another schematic view of the cover member shown in FIG. 16 according to an embodiment of the disclosure, which shows the cover member viewed from another direction.

In one or more embodiments, as shown in FIG. 17, the top plate portion 153 includes a plane portion 1532 and an inclined portion 1531, the plane portion 1532 is perpendicular to the axial direction, the inclined portion 1531 is connected to the plane portion 1532, and the portion where the inclined portion 1531 is connected to the plane portion 1532 extends toward the portion away from the plane portion 1532 to the other side (side O) in the axial direction. In this manner, by providing the inclined portion, the amount of resin can be reduced, and the cost and weight can be decreased.

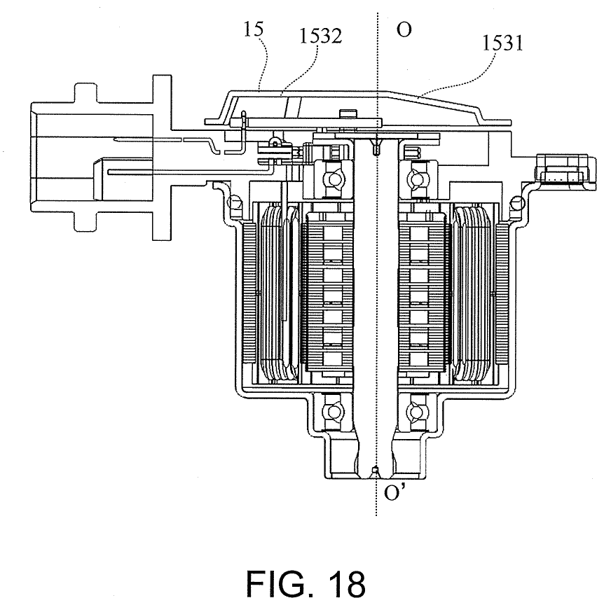

FIG. 18 is a cross-sectional view of another structure of the motor according to an embodiment of the disclosure. As shown in FIG. 18, the inclined portion 1531 is located at a position closer to the outer side in the radial direction than the central axis OO′, and the plane portion 1532 coincides with the central axis OO′ in the axial direction. In this manner, when the motor is assembled, the plane portion with a large area can be clamped by a clamp or the like, and reliable clamping during assembly can be achieved, so that the assembly operation can be easily performed. Additionally, by providing an inclined portion, the amount of resin can be reduced, and the cost and weight can be decreased. However, the disclosure is not limited thereto. For example, as shown in FIG. 1 and FIG. 17, the cover portion can also be set in the manner that the central axis 00′ coincides with the inclined portion in the axial direction, and those skilled in the art can make arrangement according to actual needs.

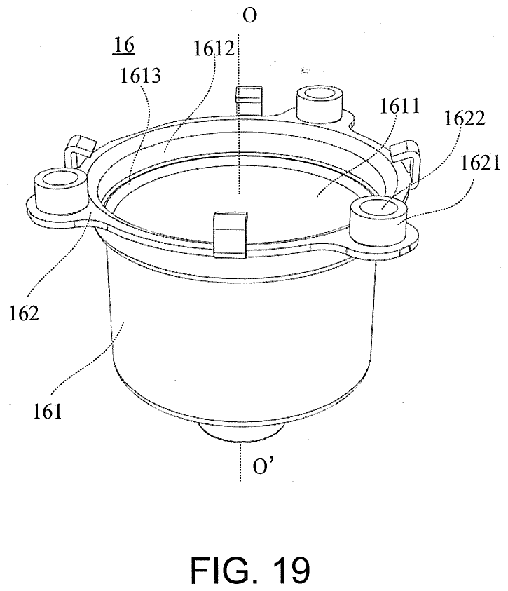

FIG. 19 is a schematic view of a housing according to an embodiment of the disclosure. As shown in FIG. 1 and FIG. 19, the motor 10 further has a housing 16, and the housing 16 holds the bus bar unit 13 and the stator 12, and the rotor 11 is located inside the housing 16. The housing 16 has a cylindrical portion 161 extending in the axial direction. The cylindrical portion 161 has a first cylindrical portion 1611, a second cylindrical portion 1612, and a stepped portion 1613. The second cylindrical portion 1612 is located at one side (side O) of the first cylindrical portion 1611 in the axial direction, the second cylindrical portion 1612 has a diameter larger than the first cylindrical portion 1611, and the stepped portion extends outward in the radial direction from the end portion of the first cylindrical portion 1611 at one side (side O) in the axial direction, and is connected to the end portion of the second cylindrical portion 1612 at the other side (side O′) in the axial direction.

In one or more embodiments, as shown in FIG. 1, the motor further has a ring member 17, which is located at one side (side O′) of the stepped portion 1613 in the axial direction, and is configured between the inner surface of the second cylindrical portion 1612 in the radial direction and the outer surface of the housing insertion portion 132a of the bus bar holder 132 in the radial direction, and the housing insertion portion 132a is formed by extending from the end surface of the bus bar holder 132 at the other side (side O′) in the axial direction toward the other side (side O′) in the axial direction. In this manner, the ring member can be limited in the axial direction through the stepped portion, and no additional support member is needed for the ring member. In the embodiment of the disclosure, the ring member may be, for example, an O-shaped ring sealing member, but the disclosure is not limited thereto.

In one or more embodiments, as shown in FIG. 19 and FIG. 7, the housing 16 further has a housing flange plate portion 162, and the housing flange plate portion 162 extends outward in the radial direction from the end portion of the cylindrical portion 161 at one side in the axial direction. The housing flange plate portion 162 has a flange portion 1621, which protrudes to one side (side O) in the axial direction from the housing flange plate portion 162, and inserts into the first mounting hole 1341 of the flange plate portion 134 of the bus bar holder 132. The first mounting hole 1341 axially penetrates the portion of the body portion 1321 of the bus bar holder 132 extending outward in the radial direction (the portion may also be referred to as the flange plate portion 134 of the bus bar holder), the flange portion 1621 has a second mounting hole 1622 penetrating in the axial direction inside the flange portion 1621. In this embodiment, the housing is made of metal material, and the first mounting hole and the second mounting hole serve as, for example, screw holes when the motor is installed with other equipment. The bus bar holder is made of resin, and if there is no flange portion, it is necessary to additionally arrange a metal sleeve in the first mounting hole. However, by providing a metal flange portion, there is no need to provide a sleeve. In the embodiment of the disclosure, the housing and the flange portion may be formed integrally, but the disclosure is not limited thereto, and the housing and the flange portion may also be formed separately.

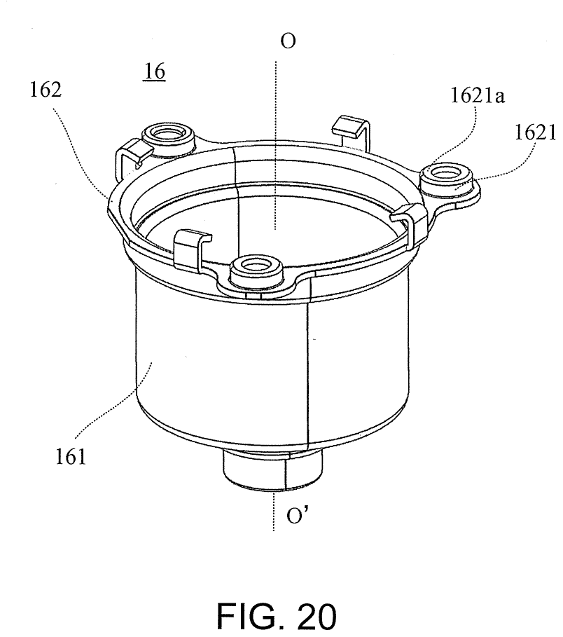

FIG. 20 is a schematic view of another structure of the housing according to an embodiment of the disclosure. In one or more embodiments, as shown in FIG. 20, the flange portion 1621 has an annular portion 1621a extending inward in the radial direction from the end portion at one side in the axial direction. In this manner, the configuration of the annular portion can increase the contact area with other mounting equipment. However, the disclosure is not limited thereto. For example, the flange portion 1621 may not be provided with an annular portion extending inward in the radial direction as shown in FIG. 18. The disclosure provides no limitation thereto, and persons skilled in the art can make arrangement according to actual needs.

Based on the above embodiments, it can be obtained that the bus bar includes a first connecting portion and a second connecting portion connected through a bending portion, and the lead-out portion of the winding is located in a slit passing through the first connecting portion and the second connecting portion to be electrically connected to the first connecting portion and the second connecting portion. That is, the lead-out portion of the winding is sequentially connected to the two connecting portions, thus ensuring the area where the bus bar is electrically connected to the winding, suppressing the increase of the contact resistance, and preventing the heat from being generated at where the bus bar is electrically connected to the winding. In addition, the connection operation for connecting the bus bar and the winding is simple.

It is worth noting that the above description only exemplifies the embodiments of the present disclosure, but the embodiments of the present disclosure are not limited thereto, and appropriate modifications can also be made on the basis of the above various embodiments. In addition, each component is only exemplified above, but the embodiment of the present disclosure is not limited thereto, and specific details regarding each component can also be derived from related technologies; in addition, components not shown in FIG. 1 to FIG. 20 may be added, or one or more components in FIG. 1 to FIG. 20 may be reduced.

The embodiments of the present disclosure have been described above in conjunction with specific implementations, but it should be clear to those skilled in the art that these descriptions are exemplary and do not limit the scope of protection of the embodiments of the present disclosure. Those skilled in the art can make various variations and modifications to the embodiments of the present disclosure according to the spirit and principles of the embodiments of the present disclosure, and these variations and modifications also fall within the scope of the embodiments of the present disclosure.

The preferred embodiments of the embodiments of the present disclosure have been described above with reference to the drawings. Many features and advantages of these embodiments are clear based on the detailed description, and therefore the appended claims are intended to cover all these features and advantages of these embodiments that fall within the true spirit and scope thereof. In addition, since those skilled in the art can easily think of many modifications and changes, it is not intended to limit the implementation of the embodiments of the present disclosure to the precise structure and operation illustrated and described in the disclosure, but to cover all suitable modifications and equivalents that fall within the scope described above.

What is claimed is:

1. A motor, comprising:
a rotor, having a shaft centered on a central axis extending in an axial direction;
a stator, arranged opposite to the rotor in a radial direction and having a plurality of coils; and
a bus bar unit, which is arranged on one side of the stator in an axial direction, wherein the bus bar unit comprises:
a bus bar, which is electrically connected to a lead-out portion of a winding forming the coil; and
a bus bar holder, which is made of resin and covers at least a part of the bus bar, the bus bar comprising:
a first connecting portion;
a second connecting portion;
a bending portion, which connects the first connecting portion and the second connecting portion; and
a slit, which penetrates the first connecting portion and the second connecting portion,
wherein the lead-out portion of the winding is located in the slit and is electrically connected to the first connecting portion and the second connecting portion.

2. The motor according to claim 1, wherein,
the number of the slit is one or more.

3. The motor according to claim 1, wherein,
the first connecting portion and the second connecting portion extend to the other side in the axial direction from the bending portion,
the slit penetrates the first connecting portion and the second connecting portion in the radial direction.

4. The motor according to claim 1, wherein,
the first connecting portion and the second connecting portion extend in the radial direction from the bending portion,
the slit penetrates the first connecting portion and the second connecting portion in the axial direction.

5. The motor according to claim 1, wherein, a width of at least a part of the slit is narrower than a diameter of the winding.

6. The motor according to claim 1, wherein,
a portion of the second connecting portion away from the bending portion is not provided with the slit.

7. The motor according to claim 1, wherein,
the bus bar holder comprises a connection support portion that protrudes from a surface of the bus bar holder on one side in the axial direction and clamps the first connecting portion and the second connecting portion in a circumferential direction.

8. The motor according to claim 1, wherein,
the bus bar holder has:
a cylindrical body portion;
a connector portion that protrudes outward in the radial direction from the body portion; and
a bottom portion that extends inward in the radial direction from an inner surface of the body portion,
wherein the bottom has a through hole penetrating in the axial direction, the lead-out portion of the winding passes through the through hole and is wound at the one side of the bottom portion in the axial direction, and the lead-out portion of the winding is electrically connected to a portion of the bus bar configured at an inner side of the connector portion in the radial direction.

9. The motor according to claim 8, wherein,
the motor further comprises a circuit board which is disposed at one side of the bus bar holder in the axial direction and is electrically connected to the stator of the motor, and is provided with a connecting hole,
the bus bur unit further comprises a sensor connector which is located on one side of the bus bar in the axial direction, and at least a part of the sensor connector is covered by the bus bar holder,
the sensor connector has a press-fit structure that is closer to an outer side in the radial direction than an end portion of the bus bar at an inner side in the radial direction, and the press-fit structure is press-fitted into the connecting hole of the circuit board and electrically connected to the circuit board,
the bottom portion has:
a circuit board support portion that extends to one side in the axial direction from the bottom portion and is in contact with a surface of the circuit board on the other side in the axial direction,
a circuit board fixing portion which extends to one side in the axial direction from the bottom portion, and fixes the circuit board along with an outer edge of the circuit board in the radial direction through a snap-fit structure.

10. The motor according to claim 8, wherein,
the bottom portion further has a winding support portion that protrudes from a surface of the bottom portion on one side in the axial direction,
the winding support portion has a recess, and the lead-out portion of the winding is embedded into the recess.

11. The motor according to claim 1, wherein,
the number of the bus bars is at least three, and each of the bus bars has the same shape.

12. The motor according to claim 8, wherein,
the bottom portion further has a winding support portion, which protrudes from a surface of the bottom portion on one side in the axial direction,
the number of the bus bars is three, and the winding support portion is located between the bus bar in a middle position among the three bus bars and the through hole.

13. The motor according to claim 8, wherein,
the through hole has a recessed portion recessed toward the bus bar, and
the lead-out portion of the winding is embedded in the recessed portion.

14. The motor according to claim 8, wherein,
the bottom portion is provided with a winding guiding portion, which protrudes to one side in the axial direction from a surface of the bottom portion at one side in the axial direction, and
a portion, ranging from the through hole to a position between the first connecting portion and the second connecting portion, of the lead-out portion of the winding is located between the winding guiding portion and the body portion in the radial direction.

15. The motor according to claim 8, wherein,
the motor further comprises a cover member made of resin, which covers the bus bar holder from one side in the axial direction,
the cover member has:
a flange plate portion that extends in the radial direction, and axially contacts an end surface of the body portion at one side in the axial direction;
a peripheral wall portion that extends to one side in the axial direction from an end portion of the flange portion at an inner side in the radial direction; and
a top plate portion that extends inward in the radial direction from an end portion of the peripheral wall portion at one side in the axial direction,
the top plate portion has a winding pressing portion that protrudes to the other side in the axial direction from a surface of the top plate portion on the other side in the axial direction, and is in contact with the lead-out portion of the winding.

16. The motor according to claim 15, wherein,
the top plate portion comprises:
a plane portion, which is perpendicular to the axial direction; and
an inclined portion, which is connected to the plane portion, and extends toward the other side in the axial direction from a portion where the inclined portion is connected to the plane portion to a portion away from the plane portion.

17. The motor according to claim 16, wherein,
the inclined portion is located at a position closer to an outer side in the radial direction than the central axis,
the plane portion and the central axis coincide in the axial direction.

18. The motor according to claim 1, wherein,
the motor further has a housing that holds the bus bar unit and the stator, the rotor is located inside the housing,
the housing has a cylindrical portion extending in the axial direction,
the cylindrical portion has:
a first cylindrical portion;
a second cylindrical portion, which is located at one side of the first cylindrical portion in the axial direction, and the second cylindrical portion has a diameter larger than the first cylindrical portion; and
a stepped portion that extends outward in the radial direction from an end portion of the first cylindrical portion at one side in the axial direction, and is connected to an end portion of the second cylindrical portion at the other side in the axial direction,
the motor further has a ring member located at one side of the stepped portion in the axial direction, and is configured between an inner surface of the second cylindrical portion in the radial direction and an outer surface of the housing insertion portion of the bus bar holder in the radial direction, the housing insertion portion is formed by extending toward the other side in the axial direction from an end surface of the bus bar holder on the other side in the axial direction.

19. The motor according to claim 1, wherein,
the motor further has a metal housing, which holds the bus bar unit and the stator, and the rotor is located inside the housing,
the housing has:
a cylindrical portion extending in the axial direction;
a housing flange plate portion that extends outward in the radial direction from an end portion of the cylindrical portion at one side in the axial direction, the housing flange plate portion has:
a flange portion that protrudes to one side in the axial direction from the housing flange plate portion, and is inserted into a first mounting hole of a flange plate portion of the bus bar holder, the first mounting hole axially penetrates a portion, extending outward in the radial direction, of the body portion of the bus bar holder, and
there is a second mounting hole penetrating in the axial direction inside the flange portion.

20. The motor according to claim 19, wherein,
the flange portion has an annular portion located at an end portion at one side in the axial direction and extending inward in the radial direction.
